(19) United States
(12) Patent Application Publication
(10) Pub. No.: US 2021/0256631 A1
(43) Pub. Date: Aug. 19, 2021

(54) System And Method For Digital Crop Lifecycle Modeling

(71) Applicants: HAR AMRIT PAL SINGH DHILLON, Gurgaon (IN); SUMEET SINGH, New Delhi (IN)

(72) Inventors: HAR AMRIT PAL SINGH DHILLON, Gurgaon (IN); SUMEET SINGH, New Delhi (IN)

(21) Appl. No.: 17/251,857

(22) PCT Filed: Aug. 28, 2018
(86) PCT No.: PCT/IN2018/050551

§ 371 Date: Dec. 14, 2020

(30) Foreign Application Priority Data
Jun. 15, 2018 (IN) 201811022498

(51) Int. Cl. G06Q 50/02; G06Q 10/06

(52) U.S. Cl. CPC G06Q 50/02; G06N 20/00; G06Q 10/06315

(57) ABSTRACT

A system for crop lifecycle modeling, comprising a computer processor and at least one computer-readable storage medium operably coupled to the computer processor and having program instructions stored therein, the computer processor being operable to execute the program instructions to generate a profile of a crop using a plurality of data processing modules including, a data acquisition module (106) configured to receive, periodical input data from at least one source, wherein the data is related to at least one of factors contributing to production of the crop, a data storage module (108) adapted to process and store the received input data, an analytics core module (208) configured to generate an output data using the input data from the data storage module (108) for processing and computing the input data to create a predictive crop lifecycle model, wherein the analytics core module (208) is adapted to work with a crop lifecycle rules engine (332) and provide input to improve and enhance the rules engine (332), an interface module (102) configured to process and transfer the output data, instructions and conduct transaction between multiple users of the data processing modules, and a report module configured to generate an action report from the interface module based on the data of the analytics core module.

### TECHNICAL FIELD OF THE INVENTION

The present invention relates in general to the field of agriculture, and more particularly to a system and method for maximizing farm profitability from perishable farming using cropping windows and dynamic digital crop lifecycle modeling. The present invention is also directed to utilizing such information for, among other purposes, real time decision making by farmers, significantly reduce their risk of cropping failure, predictive modeling for crop lifecycle, and create sustainable agriculture processes all to optimize crop production.

### BACKGROUND OF THE INVENTION

Different farmers around the world especially in the developing world characterized by small farm holding with low or no mechanization use different practices and is generally a function of local customs, beliefs, geography, history, and inherited traditional knowledge. While everyone tries to maximize profit from farm or crop production, farmers and farm managers use a variety of methods. Some farmers have more knowledge, funds, manpower and options at their disposal, while majority of farmers lack access to modern techniques and information for increasing crop profitability potential.

As per United Nations Population Fund, the population growth in the world is expected to be 9.6 billion by 2050. This growth is mainly in developing countries, creating a need to feed billions of additional people. Importance of fruits, vegetables and other perishable crops in every day diet has been well proven by various research and academic bodies, with this growing population the necessary nutritious diet will become a luxury and a major part of our population will keep away from it.

Additionally, farmers in the developing countries, such as parts of Asia, Africa & South America are typically associated with small farms. The HLPE report, 2000 round, found that in 81 countries of its study 73% of farms were smaller than 1 hectare and 85% were smaller than 2 hectares. This denotes level of access to farming resources by farmers. For such farmers, farming as a profession is consistently becoming an unprofitable. The situation is especially grim for farmers engaged in cultivation of perishable produce which includes vegetables and fruits, which get further impacted by multiple variables such as demand to supply mismatch, quality sensitivity, weather impact, prone to pest, higher inputs costs like irrigation, labor, fertilizers, higher care during cultivation, low shelf life resting in damage while in stocking, high storage cost because of temperature related spoilage, high number typical middle men in perishable crops supply chain from farm to fork. The listed factors are primary drivers which results in losses of crop, entail large fluctuations in prices and impacts the yield and the net income of the farmers.

Further, while there is a considerable research done to increase productivity of crops including fruits and vegetables, reduce post-harvest spoilage by government and private enterprises, the farmers do not get easy, timely, practical, localized and decision enabling access to this information.

The current solutions available work to deliver a target state while neglecting many core parameters which would directly or indirectly affect the very premise of the solution to solve the problem. Many such known systems are available such as farmers' knowledge dissemination systems, these systems seek to provide agronomic practices and knowledge to farmers so that they could obtain higher yields and better-quality products. This is typically done by a government agency or by NGOs. These systems provide a guidebook for the farmers to grow a specific crop like tomato, carrots, potatoes etc. The systems provide details like growing period, types of seeds, soil conditions needed, potential pest attacks and best practices related to managing the crop. However, this library approach is difficult to understand and does not provide specific contextual and actionable information to the farmer to enable him to manage his cropping cycle with respect to maximization of his profit. For example, Ojay Greene (Kenya) offers training, advisory services and market access for underserved smallholder farmers and ICT4Dev (Côte d'Ivoire) integrates ICT solutions for farmers' problems through platform design, web management tools, mobile, SMS and voice. Further, AgroSpaces (Cameroon) is a networking site connecting agricultural communities to share information and form valuable connections.

One other type of offered solution is a farm automation system, such systems enable large corporate contract farming entities to manage the end to end farming process. So, while they automate the process, they provide very little actionable intelligence at the various stages of cropping. Such systems are primarily of use to farmers who own large tracts of land or to corporates dealing with contract farming. For small farmers, who own a small piece of land such systems are either too complex or do not provide specific and timely actionable information to maximize their profits. For example, cropin.com and farmerp.com.

Further, new age market pricing information systems provide real time/near real-time information on the actual produce being sold or transacted through marketplaces. Such software could be of use to the traders who can maximize their business opportunity by looking at the currently prevailing price and taking decisions on how much to stock, buy and sell. However, such system is of less use to the farmers because the farmers actual cropping and harvest decision has already happened in past and this information does not enable them to go and fix the issue. Such examples would include, agmarknet.gov.in, digitalmandi.iitk.ac.in.

There are a few weather feed systems, which provide farmers with localized information on weather trends and alerts regarding hazardous weather incident which can negatively impact the crops. Such software provide data from neighboring weather stations or publicly available sources. So, while the information itself is useful for the ongoing cropping but it fulfils only a specific intelligence and does not necessarily enables the farmer/user to decide on crop optimization in line with intended crop profitability. For example, Trimble's farmer starter.

Another example is farming input access systems which serve as a market place and share platform to give farmers the production tools they need. While availability of production tools to small farmers is very critical how-ever such systems do not provide any intelligence in the actual cropping life-cycle so does not provide any assurance on the farm profitability. For example, Trringo offering tractor on rental model. Esoko is an information and communication service for agricultural markets in Africa that recently launched Tulaa, a marketplace for inputs. It combines mobile technology and last mile agent networks to connect input suppliers, financial service providers, and commodity buyers to smallholder farmers. SunCulture, a start-up in Kenya is proposing an innovative solution. Their AgroSolar Irrigation Kit is a solar-powered irrigation system—a solar water pumping technology and a high-efficiency drip irrigation, bundled with a “pay-as-you-grow” financing service.

The systems further provide farm sensing & IoT systems capabilities in limited functions where data on soil and crops are obtained with sensors and farmers can get real-time information and advice by SMS. The limitation of such systems is that they support large farms and such technology solutions typically are not feasible for small farmers because of costs and technology complexities. For example, KaaProject is an open-source IoT Platform that uses different sensors, connected devices, and farming facilities to streamline the development of farming.

New age solutions also include agriculture supply chain management systems, these systems provide technology solutions that includes quality testing devices, sensors for products' traceability and safety, and smart logistics. Such solutions help in reducing the supply chain losses as well making it for efficient and visible, they do not however improve the profitability of the send farmer. Such as, FarmSoft, iProcure (Africa) procurement, last-mile distribution, business intelligence and data-driven stock management across the supply chains, and AfriSoft addresses warehouse management, quality, traceability and production tracking.

The agriculture business marketplace systems enable farmers to sell their products online, reaching final customers and increasing their revenues. They reduce the number of middlemen and provide farmers the market connectivity. Market access is crucial to cut the intermediaries but its only one step in addressing the problem. For example, M-Farm which connects farmers directly to buyers and inform them of price trends to optimize planting and harvesting timing.

Therefore, with a rapidly growing world population, importance of crop produce including fruits and vegetables in the diet and the poor condition of farmers in developing world, there is a critical need to manage the crops, optimize production and increase crop profitability. However, no such comprehensive platform or system exist today. There are specific point solutions for various aspects related to farming but none of them meets the actual need of a farmer to maximize his profits from his farm. The present invention is directed to fulfilling these and other needs and is described below.

### SUMMARY OF THE INVENTION

The various embodiments and examples of the present invention as presented herein are understood to be illustrative of the present invention and not restrictive thereof and are non-limiting with respect to the scope of the invention.

It is one objective of the present invention to offer an intelligent technology platform, system, and a method that can provide increased farm yields as well as profitability to farmers. The system provides full lifecycle risk management for perishable crops and provide step by step and practical actionable intelligence to the farmers in an easy to understand, intuitive and contextualized information manner. The system is dynamic in nature and can alter the intelligence based on the evolving variables like market demand, prices, weather, etc. by leveraging big data analytics, statistics and access to multiple variables which can influence any aspect of perishable cropping.

It is an object of the present invention to provide a system and method of providing higher agricultural output for agricultural products throughout cropping lifecycle and distribution and use of the same for, among other purposes, communication, real time decision making, predictive modeling, risk sharing and/or sustainable agriculture purposes.

It is an object of the present invention to provide a system and method for a comprehensive full lifecycle approach for perishable crops from crop selection to selling harvest utilizing complex multi-correlation algorithms and analytics-based system and method that would enable farmers cultivating perishable crops to significantly reduce their risk of cropping failure and at the same time enable them to maximize their net profit.

In one embodiment, the present invention relates to a system for crop lifecycle modeling, having a computer processor, and at least one computer-readable storage medium operably coupled to the computer processor and having program instructions stored therein, the computer processor being operable to execute the program instructions to generate a profile of a crop using a plurality of data processing modules including, a data acquisition module configured to receive, periodical input data from at least one source, wherein the data is related to at least one of factors contributing to production of the crop, a data storage module adapted to process and store the received input data, an analytics core module configured to generate an output data using the input data from the data storage module for processing and computing the input data to create a predictive crop lifecycle model, wherein the analytics core module is adapted to work with a crop lifecycle rules engine and provide input to improve and enhance the rules engine, an interface module configured to process and transfer the output data, instructions and conduct transaction between multiple users of the data processing modules, a report module configured to generate an action report from the interface module based on the data of the analytics core module.

Further, the present invention relates to a system where the factors contributing to production of the crop includes at least one of geography, demographics, soil condition, market condition, weather, and government policy.

Further, the present invention relates to a system where the analytics core module, for creating a predictive model, further includes a ‘Provisioning & Rendering Module’, a ‘Dynamic Digital Crop Lifecycle Modeling Module, a ‘Cropping Window Detection Module’, a ‘Demand Determination Module’, a ‘Target Market Price Determination Module’, a ‘Crop Opportunity Sizing & Prioritizing Module’, a ‘Cropping Area Recommendation Module’, a ‘Harvest Timing & Sizing Module’, and a ‘Hub Surround Intelligence Module’, wherein the modules generates instructions for at least one of maximizing yield, determining demand, calculating target price, identifying right crop opportunity.

Further, the present invention relates to a system where the analytics core module provides the inputs to improve and enhance instructions underlying in the data processing, computing, and instructions generating modules.

Further, the present invention relates to a system having an interface layer of the interface module configured to work with an acquisition interface layer of an acquisition module.

Further, the present invention relates to a system where the data received is generated in real time or dynamically.

Further, the present invention relates to a system where having a localization engine to convert the output data of the analytics core module into a set of instructions.

Further, the present invention relates to a system where the data processing and computing modules of the analytics core module, utilizes multi correlation instructions and analytics, and generates a set of instructions to optimize crop production.

In yet another embodiment, the present invention relates to a method for crop lifecycle modeling, having receiving periodical input data from at least one source, wherein the data is related to at least one of factors contributing to production of the crop, storing the received input data, computing an output data using the input data for creating a predictive crop lifecycle model using a crop lifecycle rules engine and provide input to improve and enhance the rules engine, transferring the output data, instructions and conducting transaction between multiple users, generating periodical reports to users based on the predictive crop lifecycle model.

Further, the present invention relates to a method where the factors contributing to production of the crop includes at least one of geography, demographics, soil condition, market condition, weather, and government policy.

Further, the present invention relates to a method where computing the input data for creating a predictive crop lifecycle model further includes providing a unique framework for developing a structured database of a digital mode, generating a dynamic digital crop lifecycle model, determining a cropping window model, determining a demand volume, determining a target market price, identifying crop opportunity size, recommending a cropping area, recommending a harvest time, validating the predictive crop lifecycle model using a hub surround data.

Further, the present invention relates to a method including converting the output data into a set of instructions to optimize crop production.

In yet another embodiment, the present invention relates to a method implemented by a computer for crop lifecycle modelling, having receiving dynamic input data wherein the input data is related to at least one of factors contributing to production of the crop, generating contextual instructions and a predictive crop lifecycle model by computing the dynamic input data using rules from a rules engine for users, improving and enhancing the rules engine using the generated contextual instructions.

Further, the present invention relates to a method having processing, by a computer, and storing the received input data.

Further, the present invention relates to a method where generating contextual instructions further includes transferring an output data, instructions and conducting transaction between multiple users.

Further, the present invention relates to a method where further includes providing periodical reports to users based on the predictive crop lifecycle model.

In yet another embodiment, the present invention relates to a system for a crop lifecycle modelling, having an electronic module configured to provide a user interface, a network storage device configured to store crop lifecycle data and adapted to work with the electronic module, a predictive modelling module, configured to process the crop lifecycle data on the network storage device, including a modelling input module configured to receive dynamic input data relating to a crop production parameter from at least one of plurality of sources, a modelling output module configured to generate a crop production improvement parameter by processing the input data from the modelling input module in accordance to rules from a rules engine, and a predictive module configured to generate models, instructions and reports from the input and output modules to optimize crop production and enhance the rules engine.

These and other aspects, processes and features of the invention will become more fully apparent when the following detailed description is read with the accompanying figures and examples. However, both the foregoing summary of the invention and the following detailed description of it represent one potential embodiment, and are not restrictive of the invention or other alternate embodiments of the invention.

### BRIEF DESCRIPTION OF DRAWINGS

To illustrate the solutions according to the embodiments of the present disclosure more clearly, the accompanying drawings needed for describing the embodiments are introduced below briefly. Apparently, the accompanying drawings in the following descriptions merely show some of the embodiments of the present disclosure, and persons skilled in the art may obtain other drawings according to the accompanying drawings without creative efforts.

FIG. 1 illustrates a schematic diagram of a system of a crop lifecycle model, according to an embodiment of the invention;

FIG. 2 is a schematic diagram of data flow within components of a crop lifecycle model, according to an embodiment of the invention;

FIG. 3 is a schematic diagram of a system along with sub components of a crop lifecycle model, according to an embodiment of the invention;

FIG. 4 is a schematic diagram of a system with a user interface, according to an embodiment of the invention;

FIG. 5 is a schematic diagram of a system for crop lifecycle modeling, according to an embodiment of the invention;

FIG. 6 is a flow chart representing an example of a program that can be executed for digital dynamic crop lifecycle model, according to an embodiment of the invention;

FIG. 7 is a flow chart representing an example of a program that can be executed for cropping window for a specific geo code model, according to an embodiment of the invention;

FIG. 8 is a flow chart representing an example of a program that can be executed for crop demand for a specific geo code model, according to an embodiment of the invention;

FIG. 9 is a flow chart representing an example of a program that can be executed for target market price for a specific crop model, according to an embodiment of the invention;

FIG. 10 is a flow chart representing an example of a program that can be executed for crop opportunity sizing and prioritization model, according to an embodiment of the invention;

FIG. 11 is a flow chart representing an example of a program that can be executed for cropping area recommendation for a specific farmer model, according to an embodiment of the invention;

FIG. 12 is a flow chart representing an example of a program that can be executed for harvest timing & sizing model, according to an embodiment of the invention;

While the invention is amenable to various modifications and alternative forms, some embodiments have been illustrated by way of example in the drawings and are described in detail below. The intention, however, is not to limit the invention by those examples and the invention is intended to cover all modifications, equivalents, and alternatives to the embodiments described in this specification.

### DETAILED DESCRIPTION OF THE INVENTION

The solutions of the present disclosure are to be clearly described in the following with reference to the accompanying drawings. It is obvious that the embodiments to be described are only a part rather than all the embodiments of the present disclosure. All other embodiments obtained by persons skilled in the art based on the embodiments of the present disclosure without creative efforts shall fall within the protection scope of the present disclosure

According to one non-limiting embodiment of the present invention, an agricultural system for at least one agricultural product has a system and method consist of a data collection module that receives and processes wide variety of static and dynamic data which includes location information, demographics, cropping information, weather information, market price, soil type, historical consumption and puts it into a complex structured database. Subsequently, an analytics module processes all or some of this information and generates precise information relating to various stages of a cropping lifecycle which are then rendered through a multilingual user interface accessible through a lightweight mobile app as well as a desktop application to farmers or farm managers.

Apart from the farmers, a hub is also conceptualized as a necessary node for both physical cropping produce handling and management as well as a supplementary dissemination node for advanced cropping intelligence. A hub is the key enabler and an on-ground working entity. It services the fresh produce for the market/city around which they are anchored, and it is manned by approved representatives. The Hub would be supported by a business interface which would have all software and technology modules for it to function effectively and efficiently. While the information to farmers would be rendered through a data light mode, with its high bandwidth and speed connectivity, the hub would have the ability to access larger information which it can locally disseminate to the farmers attached to it.

Within the meaning of this specification, communication happens on an open communication network representing a network that can be accessed by additional devices coming into or onto the network, such as the internet. Alternatively, a wide area network or (WAN) could form an open communication network within the meaning of this application, wherein a WAN is a telecommunication network that covers a broad area (e.g., any network that links across metropolitan, regional, or national boundaries). For example, business and government entities often utilize WANs to relay data among employees, clients, buyers, and suppliers from various geographical locations. Additionally, a collection of interconnected Local Area Networks (LANs) could form an open communication network within the meaning of this application where one or more of the LANs can be accessed by additional devices coming into or onto the interconnected networks. With the rapid rate of advancement of science and technology in this area it is very difficult to predict all the permutations of an open communications network that may come into being during the term of this patent, but nonetheless such devices are within the scope of this invention if they can perform the functions described herein about the open communication network of the present invention.

The present invention will be described in some instances connection with agricultural products in the form of cultivating crops on a typical farm and seeing them through to final consumption by an end user/consumer. However, is reiterated and it is to be clearly understood that the present invention is not so limited, and the present invention applies to all forms of agricultural product production, whether the agricultural product is animal (e.g. livestock, fish, poultry, dairy etc.), or plant, (e.g. corn, rice, soy, etc.), and whether it is produced for a food or a non-food use such as but not limited to clothing, medicine or any other use. Each of the modules of the above system are described below in detail in the following sections.

It is the principal object of the present invention to offer an intelligent technology platform, system, and a method that can provide increased farm yields as well as profitability to farmers. The system provides full lifecycle risk management for perishable crops and provide step by step and practical actionable intelligence to the farmers in an easy to understand, intuitive and contextualized information manner. The system is dynamic in nature and can alter the intelligence based on the evolving variables like market demand, prices, weather, etc. by leveraging big data analytics, statistics and aces to multiple variables which can influence any aspect of perishable cropping.

It is an object of the present invention to provide a system and method of providing higher agricultural output for agricultural products throughout production and distribution and use of the same for, among other purposes, communication, real time decision making, predictive modeling, risk sharing and/or sustainable agriculture purposes.

It is an object of the present invention to provide a system and method for a comprehensive full lifecycle approach from crop selection to selling harvest for perishable crops utilizing complex multi correlation algorithm and analytics-based system and method that would enable farmers cultivating perishable crops to significantly reduce their risk of cropping and at the same time enable them to maximize their net profit.

In accordance with a preferred embodiment of this invention, there is provided a system for crop lifecycle modeling, having a computer processor, and at least one computer-readable storage medium operably coupled to the computer processor and having program instructions stored therein, the computer processor being operable to execute the program instructions to generate a profile of a crop using a plurality of data processing modules including, a data acquisition module configured to receive, periodical input data from at least one source, wherein the data is related to at least one of factors contributing to production of the crop, a data storage module adapted to process and store the received input data, an analytics core module configured to generate an output data using the input data from the data storage module for processing and computing the input data to create a predictive crop lifecycle model, wherein the analytics core module is adapted to work with a crop lifecycle rules engine and provide input to improve and enhance the rules engine, an interface module configured to process and transfer the output data, instructions and conduct transaction between multiple users of the data processing modules, a report module configured to generate an action report from the interface module based on the data of the analytics core module.

Further, the present invention relates to a system where the factors contributing to production of the crop includes at least one of geography, demographics, soil condition, market condition, weather, and government policy.

Further, the present invention relates to a system where the analytics core module, for creating a predictive model, further includes a provisioning & rendering module, a dynamic digital crop lifecycle modeling module, a cropping window detection module, a demand determination module, a target market price determination module, a crop opportunity sizing & prioritizing module, a cropping area recommendation module, a harvest timing & sizing module, and a hub surround intelligence module, wherein the modules generates instructions for at least one of maximizing yield, determining demand, calculating target price, identifying right crop opportunity. Further, the present invention relates to a system where the analytics core module provides the inputs to improve and enhance instructions underlying in the data processing, computing, and instructions generating modules.

Further, the present invention relates to a system having an interface layer of the interface module configured to work with an acquisition interface layer of an acquisition module.

Further, the present invention relates to a system where the data received is generated in real time or dynamically.

Further, the present invention relates to a system where having a localization engine to convert the output data of the analytics core module into a set of instructions.

Further, the present invention relates to a system where the data processing and computing modules of the analytics core module, utilizes multi correlation instructions and analytics, and generates a set of instructions to optimize crop production.

In accordance with a preferred embodiment of this invention, there is provided a method for crop lifecycle modeling, having receiving periodical input data from at least one source, wherein the data is related to at least one of factors contributing to production of the crop, storing the received input data, computing an output data using the input data for creating a predictive crop lifecycle model using a crop lifecycle rules engine and provide input to improve and enhance the rules engine, transferring the output data, instructions and conducting transaction between multiple users, generating periodical reports to users based on the predictive crop lifecycle model.

Further, the present invention relates to a method where the factors contributing to production of the crop includes at least one of geography, demographics, soil condition, market condition, weather, and government policy.

Further, the present invention relates to a method where computing the input data for creating a predictive crop lifecycle model further includes providing a unique framework for developing a structured database of a digital mode, generating a dynamic digital crop lifecycle model, determining a cropping window model, determining a demand volume, determining a target market price, identifying crop opportunity size, recommending a cropping area, recommending a harvest time, validating the predictive crop lifecycle model using a hub surround data.

Further, the present invention relates to a method including converting the output data into a set of instructions to optimize crop production.

In accordance with a preferred embodiment of this invention, there is provided a method implemented by a computer for crop lifecycle modelling, having receiving dynamic input data wherein the input data is related to at least one of factors contributing to production of the crop, generating contextual instructions and a predictive crop lifecycle model by computing the dynamic input data using rules from a rules engine for users, improving and enhancing the rules engine using the generated contextual instructions.

Further, the present invention relates to a method having processing, by a computer, and storing the received input data.

Further, the present invention relates to a method where generating contextual instructions further includes transferring an output data, instructions and conducting transaction between multiple users.

Further, the present invention relates to a method where further includes providing periodical reports to users based on the predictive crop lifecycle model.

In accordance with a preferred embodiment of this invention, there is provided a system for a crop lifecycle modelling, having an electronic module configured to provide a user interface, a network storage device configured to store crop lifecycle data and adapted to work with the electronic module, a predictive modelling module, configured to process the crop lifecycle data on the network storage device, including a modelling input module configured to receive dynamic input data relating to a crop production parameter from at least one of plurality of sources, a modelling output module configured to generate a crop production improvement parameter by processing the input data from the modelling input module in accordance to rules from a rules engine, and a predictive module configured to generate models, instructions and reports from the input and output modules to optimize crop production and enhance the rules engine.

The foregoing and other objects, features and advantages of the invention as well as the presently preferred embodiment thereof, will become more apparent from the accompanying drawings in which:

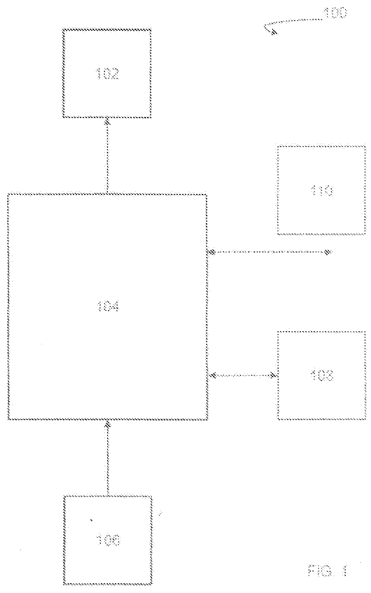

FIG. 1 illustrates a schematic diagram of a system 100 of a crop lifecycle model, according to an embodiment of the present invention. In an embodiment, a data acquisition module 106 is part of the system 100, the data acquisition module 106 provides an integration interface to connect and receive data from relevant real time or static or dynamic data sources or portals or databases for subsequent processing. For e.g. data source could be a zip code datastore, a unique identity information data source, a land record repository store, any market data, satellite imagery feeds etc.

Further, the data acquisition module 106 feeds or shares the data with a predictive core module 104, the predictive core module 104 has computer processor, a RAM memory and other processing tools to receive, process and share the information with other modules of the system 100. The predictive core module 104 enables analytics by way of various methods such as, but not limited to, data visualization, machine learning, and statistical analysis tools that allow determination of complexity of underlying patterns, trends and behaviors at a micro level.

The predictive core module 104 provides the intelligence that constantly improves and enhances a rules engine of the module 104 as well as the various other algorithms that generate intelligence. A data storage module 108 communicates with the predictive core module 104 and takes a vital role in the present invention and may be part of a computer. Information, primarily in the form of structured and unstructured data, coming from numerous sources, is saved and retrieved at data storage module 108 by the predictive core module 104.

Within the meaning of this specification, in its broadest sense data on the data storage module 108 references a device capable of storing information and/or data, without limitation to its design components and regardless of how or on what media the information is stored. It is preferred that the data storage module 108 is an information storage device, capable of retrieval and other manipulation of the information it is storing. With the rapid rate of advancement of technology in this area it is very difficult to predict all the permutations of information storage devices that may come into being during the term of this patent, but nonetheless such devices are within the scope of this invention if they can perform the functions described herein about the information storage device of the present invention. Presently, in one embodiment, the information storage device can be an electronic data storage device to store and retrieve that data, such as a computer data storage device. Data may be stored in either an analog or digital format on a variety of media, and the media is not limiting to the present invention.

The predictive core module 104 does specific data processing, computing and intelligence generation using multiple sub-modules and are detailed in subsequent drawings. The predictive core module 104 processes the data and sends meaningful, decision enabling information to a user through a user interface module 102, the user interface module 102 covers a user Interface through a presentation layer. The user interface module 102 helps relevant stakeholders to interact with the system 100, provide inputs, view different reports in an easy to understand and intuitive way. It uses dashboards to show the results and intended outcomes using specific mobile or web applications.

In an embodiment, a predictive core module 104 communicate with third party API 110, by a uni-direction or bi-direction interface by way of which third parties can connect with various modules described in the previous sections for transfer of content and data. The third-party API 110 helps in exchange of data using APIs (Application Program Interface) for bulk file transfers, batch uploads etc. The module also archives the data/content in a structured manner for future use purposes.

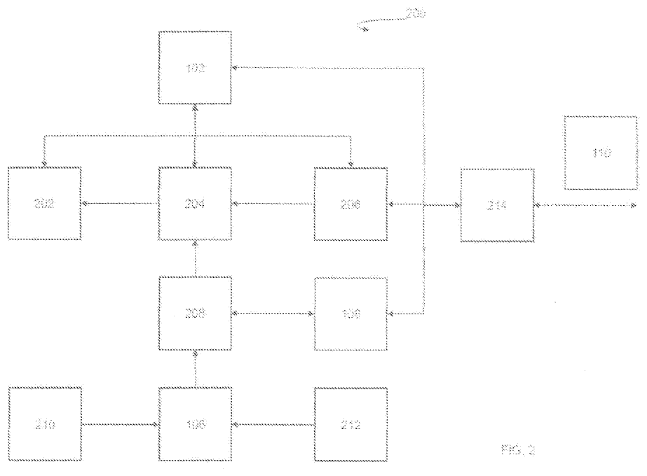

FIG. 2 is a schematic diagram of data flow of a system 200 within components of a crop lifecycle model, according to an embodiment of the present invention. In an embodiment, a data acquisition module 106 is part of the system 200, the data acquisition module 106 provides an integration interface to connect and receive data from relevant real time or static or dynamic data sources or portals or databases for subsequent processing. Two type of data sources feed into the data acquisition module 106, such as a plurality of static data sources into a periodic data source 210 and a plurality of real time data sources into a dynamic data source 212.

In one embodiment, a predictive core module 104 includes an analytics core engine module 208. The analytics core engine module 208 enables data analytics by way of data visualization and statistical analysis tools that allow determination of complexity of underlying patterns, trends and behaviors at a macro & micro level. The analytics core engine module 208 communicates with a data storage module 108. Information, primarily in the form of data, coming from numerous sources, is saved and retrieved at the data storage module 108 by the analytics core engine module 208.

In one embodiment, a predictive core module 104 further includes a localization engine module 204, a content engine module 206, a business interface 202. The localization engine module 204 is the center of operations which receive data, instructions from the analytics core engine module 208 and the content engine module 206 to further share the instructions with the business interface 202.

All the three modules, the localization engine module 204, the content engine module 206, and the business interface 202 communicates with a user interface & presentation layer 102 which helps relevant stakeholders interact with system 100 by providing inputs and variables, to view different reports in an easy to understand, intuitive dashboard forms using mobile/web apps/applications.

The localization engine module 204 generates an information/data for an end user/farmer/farm manager by localizing information to make it easily consumable by the end users. The localization engine module 204 receive the content from the analytics core engine module 208 and content engine 206 where-in the latter collects, manages and publishes content from various sources like subject matter experts, advisory entities, socio-culture entities, to interface with each other with respect to sharing information and intelligence as well as conduct transactions in a secure and automated manner. The localization engine module 204 to convert the output data of the analytics core module into a set of instructions in local language, unit of measurement and script.

Content into the content engine module 206 can be ported through a third-party integration interface 214 which in turn receive the content via APIs 110. The localization engine module 204 provides the relevant and processed information to the business interface 202 which provides interface to the hub operators which is relevant for all stakeholders such as, farmers, produce buyers, produce management intermediaries.

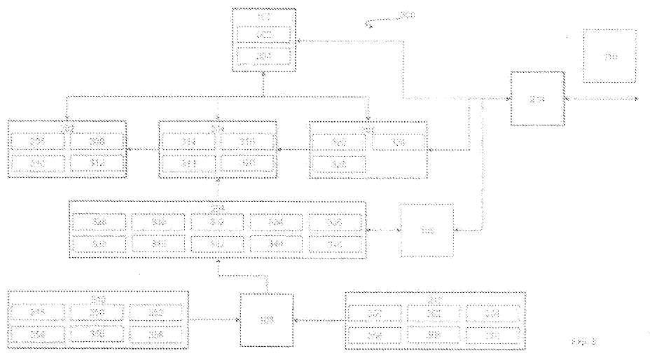

FIG. 3 is a schematic diagram of a system 300 along with sub components of a crop lifecycle model, according to an embodiment of the present invention. In an embodiment, a data acquisition module 106 as part of the system 300 uses a data acquisition gateway and receives data from a periodic data source 210 having a plurality of data sources and from a dynamic data source 212 having a plurality of data sources for subsequent processing.

A periodic data source 210 covers data sources including but not restricted to farmers profile 348 (Identity cards/national identification cards/Social security numbers/voter cards), crop growth distribution 350 (agriculture census, private/government published data, research body data), district and geo data 352 (government postal department, agricultural department DB), and cropping 354 (agriculture ministry, publication) etc.

The dynamic data source 212 covers but not limited to weather including satellite imagery 360 (AgriMet, weather portals, hyperlocal weather feeds, sensors at hub, Space research entities like NASA, ISRO, SPACEX), maps including satellite imagery 362 (maps providers such as Google, Google Earth), location 364 (GPS Mobile), crop pricing data 366 (AgriCoop, Department of Agriculture Collaboration, Research bodies), eCom retail price data 368 (E-Com websites), visual imagery 370 (drones, mobile camera), and Internet of things (IOT) data (sensors/meters/IOT devices deployed) etc.

Some data can be come through both the periodic data source 210 or the dynamic data source 212 based on the usage and frequency of update required, such data would cover market demand 356 (farm markets, farm market boards or such private or government agencies), land holding records 358 (govt land records), soil types (govt records, IOT sensor, manual inspection), and pest information (Ministry of Agriculture, National Agricultural Research Institutes) etc.

In an embodiment, an analytics core engine module 208 enables deep big data analytics by way of data visualization and statistical analysis tools that allow determination of complexity of underlying patterns, trends and behaviors at a micro level. Specific data processing/computing and intelligence generating modules of this master module 208 are detailed along with their processing logics. The analytics core engine module 208 includes a provisioning & rendering module 328, a hub surround awareness module 330, a rules engine & notification module 332, a dynamic digital crop lifecycle modelling module 334, a cropping window detection module 336, a demand determination module 338, a target market price determination module 340, a crop opportunity sizing & prioritizing module 342, a cropping area recommendation module 344, a harvest timing & sizing module 346.

The provisioning & rendering module 328 of the analytics core engine module 208 provides a unique framework for developing a structured database wherein all data is assimilated to develop a digital model of the farm, farmer and impacting intelligence. This provisioning enables creation of system models that enables subsequent processing of data by platform rules and analytics engines for dynamic processing towards generating specific contextualized and decision-making intelligence. Data captured through a data acquisition gateway of a data acquisition module 106 will be normalized, categorized and enriched by this engine to ensure context is added for generating digital models.

The hub surround awareness module 330 of the analytics core engine module 104 generates hyperlocal and localized intelligence around a pre-defined geographical area/cluster or radius called a hub. The modules generated intelligence and visibility of what is being grown in the hub is based on multiple input data. The intelligence generated by the hub surround awareness module 330 enables better decision making by all the farmers in the cluster with respect to their entire cropping lifecycle from crop selection to harvesting. The hub surround awareness module 330 also enables early identification of pest attacks as well as estimation of the expected yields based on the health of crops and the growth patterns. The intelligence in this module 330 is generated by multi-tiered validation involving but not limited to the data sources such as based on crop selection by individual farmers in the user interface, aerial (satellite, drone) imagery and crop color and texture-based identification, field inspections. The hub surround awareness module 330 uses unique algorithms to correlate information from multiple sources and assign trust scores before publishing the outputs. Unreliable and untrusted information is eliminated by algorithms during internal processing. The hub surround awareness module 330 generates periodic updates on the surround intelligence covering the total farm area under cultivation for a crop type, early or late harvest readiness and spread, the overall health of the crops in the hub & the expected yields. The hub surround awareness module 330 provides inputs to the cropping area recommendation module 344 at the time of crop selection. Subsequently it provides intelligence to all the other modules like the rules engine module 332 in case there is a pest attack, the harvest planning module 346 for scenarios of over-supply or shortage expected for a specific crop time enabling the connected farmers to take the right decision or corrective actions.

The rules engine & notification module 332 of the analytics core engine module 208, would provide, based on the dynamic digital crop lifecycle modelling, a step by step precise and predictive intelligence to manage the crop in such a way to maximize the quality as well as the crop yield. Wherever there is a deviation in actual crop lifecycle progress and the ones predicted by the crop lifecycle model, this module provides various correlations between dependent and independent variables to identify root causes for the variations and the corrective steps needed to fix the issue. Below mentioned are diverse types of rules which are developed in the application through stored procedure such as, rules for pest control, rules for irrigation management, rules for crop protection, rules for weeding, rules for fertilizer application, rules for seed selection, rules for sowing, rules for harvesting. Based on the predictive as well as prescriptive recommendations, the rules engine & notification module 332 manages the alarms, alerts, suggestions coming from the crop lifecycle modelling engine and includes specific interventions needed at that specific stage of the crop lifecycle e.g. weeding or pest control treatment etc. This module processes these anomalies and provides them in a reporting module for end user access and intimation. This module processes these anomalies and provides them in the reporting module for end user access and intimation.

DDCLM generates for a specific perishable crop and its sub varieties, a digital crop lifecycle which defines all the stages in the cropping lifecycle for each GeoCrop tag from sowing to harvest based on the actual local conditions. As a next step, for each of the DDCLM generated stages, specific interventions are defined by the system as and when the cope reaches each of the stages defined by the DDCLM. These interventions are generated by Dynamic Rules Engine (DRE) and these are the specific system generated interventions that farmers are required to initiate at various stages of the DDCLM generated crop lifecycle. Like in the case of a generic crop lifecycle being converted to DDCLM, the DRE also converts the generic interventions (based on experience of the farmer, word of mouth or training provided by a farming support entity (Government, NGO etc.)) to a dynamic precise and localized intervention (like quantum of watering, weeding, pest control, exact quantity and timing of nutrient application etc.) based on the actual conditions detected from the analysis of the input data acquired by the Data Acquisition module. This DRE increases the effectiveness of the interventions as compared to traditional method which is experience based rather data based.

The dynamic digital crop lifecycle modelling module 334 provides a digital crop lifecycle model, for each of the perishable crop and varieties. The model would be generated by the crop lifecycle modelling engine which would define all the stages in the cropping lifecycle for each GeoCrop tag from sowing to harvest. The step by step process of the model is listed in description of further drawings.

The cropping window detection module 336, based on the geographical attributes, uses algorithm-based processing logical to dynamically determine the cropping window for farmers by correlating multiple variables like time of the year, weather, geographical location, farm size, irrigation availability. The step by step process of the model is listed in description of further drawings.

The demand determination module 338 generates forecasts for perishables based on the historical market data and other independent parameters viz. inflation, population growth, income growth etc. The step by step process of the model is listed in description of further drawings.

The target market price determination module 340 provides a forecasted or anticipated market price of the crops post-harvest based on historical trends, seasonal data as well as supply demand situation expected based on the statistical and predictive modelling. The step by step process of the model is listed in description of further drawings.

The crop opportunity sizing & prioritizing module 342 identifies best performance crops based on complex algorithms that factor in location information, time of the year, historical patterns of demand, pricing, consumption, cultivation, and forecasted weather, and demand. The step by step process of the model is listed in description of further drawings.

The cropping area recommendation module 344 generates target cropping area volume that is optimal for farmers maximizing their profitability. The cropping area recommendation module 344 matches the allocation of the crops with the highest profitability potential with a risk appetite and expertise (RAE) score of each of the farmers which is determined for each farmer based on his profile data captured as well as his historic feedback and performance score. The step by step process of the model is listed in description of further drawings.

The harvest timing & sizing module 346 provides accurate harvest timing intelligence. The harvest timing & sizing module 346 uses complex algorithms to identify and prioritize the harvest activities so as the harvest is aligned with the market demand. The step by step process of the model is listed in description of further drawings.

The analytics core engine module 208 provides intelligence processed, generated through the above listed modules and constantly improves and enhances a rules engine as well as the various other algorithms that generate intelligence through the analytics core engine module 208.

A data storage module 108 communicates with the analytics core engine 208 and has a data store (database, data warehouse & data lakes). The data storage module 108 has a core database that stores all raw and processed data in a structured and unstructured format in an intelligent, secured and simplified schema to enable easy access to all end users like farmers, hub operations team, subject matter experts, Data scientists as well as external entities through a third-party integration 214 interface. This module contains all the input data mentioned as well as the processed data coming out of the modules. Each data type is tagged intelligently so that it has a unique identity for it to be used by various rules and algorithms easily and quickly.

The analytics core engine module 208 feeds the localized information to end user through a localization engine module 204, the localization engine module 204 generates the information/data for an end user module by localizing the information to make it easily consumable by the end users. The key localization done by the module 204 are a unit conversion module 314 that converts information into regionally used measurement & weight units to standardized and common units, a currency conversion module 316 that is used to convert currency to the locally accepted currency, an interface localization module 318 that will present interface in language and layout that is local to the region. Several options and layouts will exist within the system, and dynamically generated based on farmer profile. Further, a language translator module 320 that allows translating output into many different languages based on user preferences and profile mapping. This module has got configuration files that can be easily translated into different languages.

A content engine module 206 is used to collect, manage and publish information for various users and share with the localization engine module 204. This will be accessed by subject matter experts (SMEs) to upload relevant SME content 322 (e.g. training videos, educational articles, etc.) as well as for farmers to access the same through their mobile interface or web interface. The content can be in various forms such as video, audio, documents etc. The content engine module 206 will also be the engine to relay advisories 324 by government or research bodies which are relevant to the farmers. This module would also have cultural content 326 related to community cultural aspects like local festivals, music events etc. This module also converts the content into mobile ready, SMS and other distribution medium for easy end user consumption based on bandwidth as the content consumption aptitude of the end users. The content into this module would be ported through the third-party integration interface 214.

A business interface module 202 provides interface for all stakeholders' farmers, produce buyers, produce management intermediaries, subject matter experts, to interface with each other with respect to sharing information, as received from the localization engine module 204 and intelligence as well as conduct transactions in a secure and automated manner. The key functionalities of the business interface module 202 and associated tasks are spread over a supply chain management module 306, a hub management module 308, a produce traceability module 310, and a hub support tools 312. Some of the key transactions/functionalities supported and enabled by this module non limited to but includes user enrollment and lifecycle management farmer profile (farm profile, B2B buyer profile, B2C buyer profile, hub profile, SME profile, ratings, rewards/loyalty, feedback); a cropping intelligence enablement demand estimation (crop selection, demand allocation, weather inputs, maximize the crop, decision support); a cropping lifecycle management (sowing, crop nurturing, harvest planning, harvesting, ask for help); an intermediary connect farmer to hub linkage (hub to buyer linkage, enhanced farmer profile, enhanced farm profile, hub enabled validations, demand estimation, demand allocation, supply & renting—IOT farm utilities, maximize farm annuity); a produce management order management (produce planning, procurement, QA & sorting, packing, stocking, logistics, delivery, billing and invoicing, produce traceability, payments); any community engagement seminar/skype/news (community networking, community events).

All the data generated by the business interface module 202, the localization engine module 204, the content engine module 206 feeds into a user interface & presentation module 102 which helps relevant stakeholders to interact with system 100 view different reports in an easy to understand, intuitive dashboards using specific apps/utilities. The user interface & presentation module 102 has one such module is a farmer's dashboard (mobile & desktop) module 302, this module contains the interface and dashboards for the farmers, one another module is a hub dashboard (mobile & desktop) module 304, this module contains the interface and dashboards for hub team. The content engine 206 works with a third-party integration interface 214 which provides a uni-direction and bi-direction interface by way of which third parties can connect with various modules described in the previous sections for transfer of content and data. The typical content that would be exchanged includes but not limited to, specific training and knowledge content for farmers like videos, audio etc., E-Commerce transaction enablement with payment gateways, feeds to social networks, advertisements from supplier of services and products to farmers, profiling data for market research agencies. The module would enable exchange of data using APIs or bulk file transfers, batch uploads etc. The module also archives the data/content in a structured manner for future use purposes.

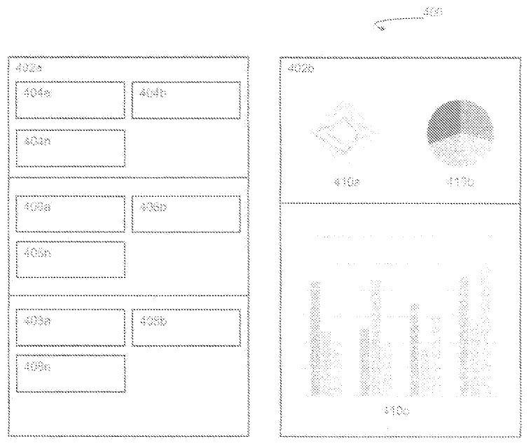

FIG. 4 is a schematic diagram of a system 400 with a user interface (UI), according to an embodiment of the present invention. A user interface and presentation layer module 102 helps relevant stakeholders to view different reports in an easy to understand, intuitive dashboards forms using specific apps or utilities. The various modules described processes all or some of this information and generates precise information relating to the various stages of the cropping lifecycle which are then rendered through a multilingual user interface accessible through a lightweight mobile app as well as a client server application to the farmers as well as the hub operators.

In an embodiment, a few sample schematics of the user interface are illustrated in 402a and 402b views. The 402a depicts a schematic for crop planning and crop lifecycle management, further 402b depicts a schematic of a user Interface for crop selection. The user interface 402a provides options for inputs parameters such as farm area, hub ID, previous crop details, capital availability, variables, sowing timeline, etc. (404a, 404b, . . . 404n) to be input by a user/farmer, while alerts, info, submit options would form the input conditions (406a, 406b, . . . 406n). Further, knowledge repository to take informed decisions such as demand estimation, hub information, historical crop success, help, price watch, farmer hub (408a, 408b, . . . 408n) forms part of the user interface 402a. The UI would be multi lingual and would render information in the local language selected by the user as part of his preferences. The UI would provide all the necessary information and intelligence to the hub operations team for their effective management of the hub for the functionality.

The UI would be multi lingual and would render cropping and related intelligence in multiple mediums (text, video, pictures, audio etc.) in the local language selected by the user as part of his preferences. The UI provides staged step by step intelligence to the farmer in the entire cropping life cycle from crop selection to actual selling o the produce. The UI also provider interface for the farmer to provide feedback, upload pictures or videos. This UI would also be accessed by farmers to participate in community engagements, seek help for their queries and other aspects of the application interface.

In an embodiment, based on information fed into a user interface 402a, a user interface 402b is presented to a user/farmer which has multiple graphical or textual information (410a, 410b, . . . 410c). This information is the processed information and has intelligence generated by a predictive core module 104 for user to take informed decisions.

This module also contains specific transactional interface and dashboards for the Hub team to support the functionality detailed in the business interface module 202.

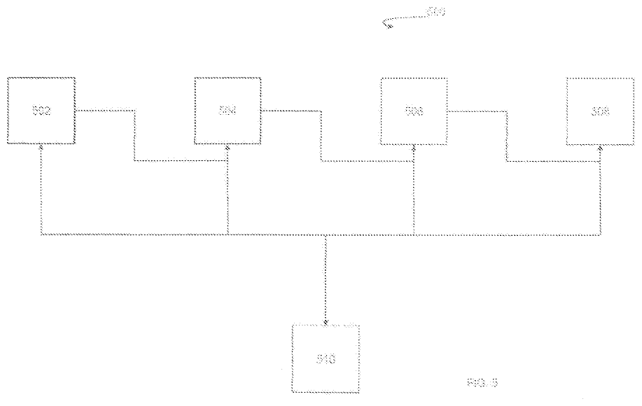

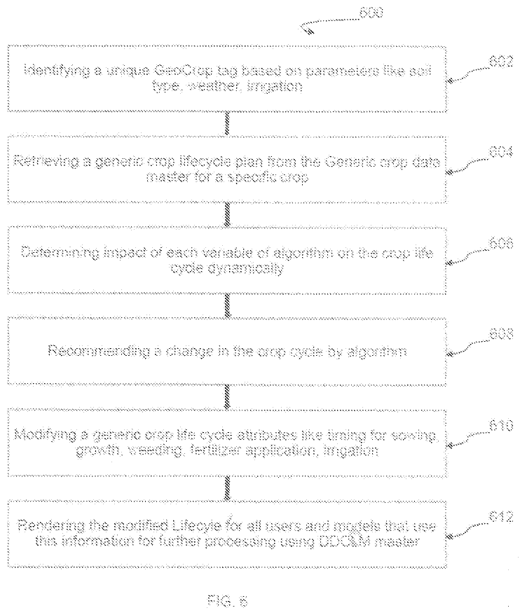

FIG. 5 is a schematic diagram of a system 500 for crop lifecycle modeling, according to an embodiment of the present invention. The system 500 depicts a high-level schematic of an exemplary method for performing a function of an analytics core engine module 208 according to aspects of the present invention. For each unique GeoCrop tag, the model identifies a Geo Tag 502, retrieves the generic crop lifecycle plan and use algorithms to find best suited plan 504. Further, modification of generic crop life cycle attributes 506 is performed to render a modified crop Lifecyle plan for all users 508. All steps and functions uses databases and master sheets 510 of an internal data storage 108. The master sheets 510 of an internal data storage 108 includes but is not limited to a Generic Crop Data Master, a Dynamic Digital Crop Lifecycle Modeling (DDCLM) Data Master, a Geo Master, a Cropping Window Master, a Historical Consumption Data Master, a Cropping Demand Model Master, a Cropping Demand Master, a Buyer Master, a Historical Price Data Master, a Cropping Price Model master, a Cropping Price Master, a Farmer profile Master, a Harvest Timing Master. The usage of above mentioned sheets 510 is explained further in detail. The high-level schematic is further explained as per individual flow charts in FIG. 6-12.

FIG. 6 is a flow chart representing an example of a program 600 that can be executed for digital dynamic crop lifecycle model, according to an embodiment of the present invention. In an embodiment, an analytics core engine module 208 includes a Dynamic Digital Crop Lifecycle Modelling module 334 (DDCLM). For each of the perishable crop and varieties, the digital crop lifecycle model 334 would be generated by a crop lifecycle modelling engine which would define all the stages in cropping lifecycle for each GeoCrop tag from sowing to harvest. A GeoCrop tag is a unique farm attribute based on the impacting conditions like soil type, weather, irrigation etc. The DDCLM model for a specific crop would be developed by overlaying the impact of factors like soil type, weather pattern, seed type, time of the year etc. on the generic growth cycles of crop thus making the generic crop lifecycle more aligned to the actual variability in field conditions. For each unique GeoCrop tag, the model would predict the critical elements of cropping that include seed germination, growth pattern of saplings, height of the plant at specific stages, color/physical characteristics of the plant, pest impact detection expected yield etc. For each unique GeoCrop tag, the model also captures the input costs at each stage of cropping from pre-sowing to harvest including cost of all inputs like seeds, labor, irrigation, fertilizer etc.

Currently for a specific crop, the crop lifecycle from “sowing to harvest “is a standard process which is based on experience of the farmer, word of mouth or training provided by a farming support entity (Government, NGO etc.). This lifecycle remains same for every farm irrespective of the various impacting variables and thus the entire cropping lifecycle cycle is an almost generic-static cycle that does not factor in the local farm conditions.

As a result, the various actions to be taken by the farmer during the cropping cycle are almost same for all farms for the same crop or same seed.

DDCLM provides a more dynamic, specific, precise and localized lifecycle for each crop based on the actual surround conditions. For each of the perishable crop and its sub varieties, a digital crop lifecycle model would be generated by the Crop Lifecycle Modelling Engine which would define all the stages in the cropping lifecycle for each GeoCrop tag from sowing to harvest. Thus, DDCLM converts the fixed generic crop lifecycle to a specific tailored lifecycle for each farm-crop combination based on the impacting Parameters. e.g. if the static method suggested pesticide treatment after 30 days of seeding, DDCLM would recommend even 20 days, 40 days etc. based on the actual data being fed into the system.

The method works on first generating a unique GeoCrop tag for each farm-crop combination which is a unique attribute for each farm based on the impacting conditions like soil type, weather, irrigation, rainfall, average hours of sunshine per day etc. For generating each unique GeoCrop tag, the model also captures the input costs at each stage of cropping from pre-sowing to harvest including cost of all inputs like seeds, labor, irrigation, fertilizer etc.

The DDCLM model for a specific crop is then generated by overlaying the impact of factors like soil type, weather pattern, seed type, time of the year etc. on the generic growth cycles of crop thus making the generic crop lifecycle more aligned to the actual variability in field conditions. For each unique GeoCrop tag, the model would predict the critical elements of cropping that include seed germination, growth pattern of saplings, height of the plant at specific stages, color/physical characteristics of the plant, pest impact detection expected yield etc.

DDCLM auto-adjusts its predictions continuously based on changes in the conditions as and when such changes are detected from the analysis of the input data being acquired by the Data Acquisition module. DDCLM algorithms would continuously and dynamically keep determining the most optimal route to achieving the best harvest based on the change in the impacting variables.

DDCLM algorithms would dynamically determining the most optimal route to achieving the best harvest based on the change in the impacting variables by executing at step 602, identifying a unique GeoCrop tag based on parameters like soil type, weather, irrigation, further, at step 604, retrieving a generic crop lifecycle plan from the Generic Crop Data Master for a specific crop. At step 606, determining impact of each variable of algorithm on the crop life cycle dynamically and at step 608, recommending a change in the crop cycle by algorithm. The modification of a generic crop life cycle attributes like timing for sowing, growth, weeding, fertilizer application, irrigation is performed at step 610 and further, at step 612, rendering the modified Lifecyle for all users and models that use this information for further processing using DDCLM Data Master.

Further, generic crop lifecycle is often too theoretical and does not incorporate several elements such as soil condition (impact from previous crops, pH and common available fertilizers in the area), change in weather (historical and predicted) during the cropping lifecycle window, and, likely pest infestation that can alter the yield or success of the crop. DDCLM will create a model by incorporating detailed elements of a crop for a given farm based on a farmer location—it will have inputs from hyperlocal sensors, hub intelligence available, records of sighted pest in neighboring farms, fertilizer available in markets and cost analysis of each of the mentioned factors. The process of FIG. 6 will identify the most optimum route to generate maximum yield value given the cost input, and can adapt to changing conditions, and will have capabilities such as machine learning to generate crop lifecycle model for each type of crop. This will help the engine to scale to generate multiple crop models, conduct cost analysis and choose the best one for the farmer. As the engine is used, it will capture multiple interaction info from the farmer through app interactions and store in appropriate context. This information will be further used to generate customized models in future for the farmer etc.

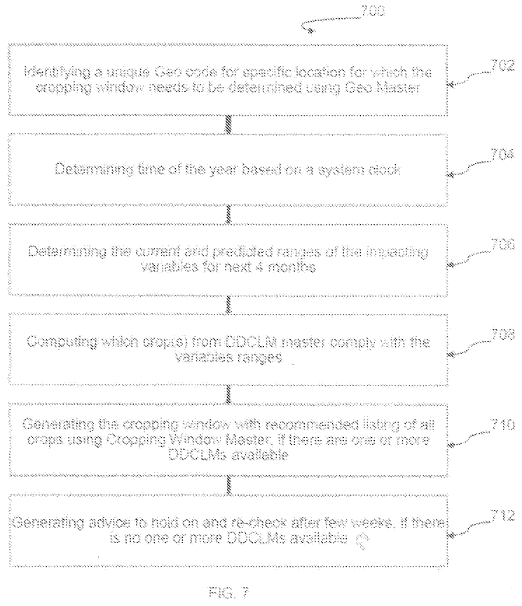

FIG. 7 is a flow chart representing an example of a program 700 that can be executed for cropping window for a specific geo code model, according to an embodiment of the present invention. In an embodiment, an analytics core engine module 208 includes a cropping windows detection module 336. For each perishable crop, a cropping windows detection model 336 would be generated, to record a minimum growth time required from soil preparation to harvest. At the same time, various impacting variables remain conducive to a specific perishable crop cultivation for a limited period and it is during this period that all elements of the environment are suitable for growth of the crop. This unique time slots are called cropping windows and which are distinct opportunity windows that are available to farmers to grow specific perishable crops to ensure maximum yield upon harvest. These cropping windows are determined by variation in the ambient conditions like temperature, humidity, rainfall, dew, sunlight etc. These cropping windows are dynamic and may be different for the same crop at two various locations in the same country/region with different geographical/geo logical/meteorological attributes.

Based on the geographical attributes, the cropping windows detection module 336 module uses algorithm-based processing logical to dynamically determine a cropping window for farmers by correlating multiple variables like time of the year, weather, geographical location, farm size, irrigation availability. The cropping windows detection module 336 has inbuilt algorithms and rules that identifies the unique cropping windows as they occur. An active cropping window is determined by the system algorithms by executing at step 702, identifying a unique Geo code for specific location for which the cropping window needs to be determined using Geo Master and at step 704, determining time of the year based on a system clock. Using step 706, determining the current and predicted ranges of the impacting variables for next 4 months and further at step 708, computing which crop(s) from DDCLM master comply with the variables ranges. The module performs at step 710, generating the cropping window with recommended listing of all crops using a Cropping Window Master, if there are one or more DDCLMs available and at step 712, generating advice to hold on and re-check after few weeks, if there is no one or more DDCLMs available.

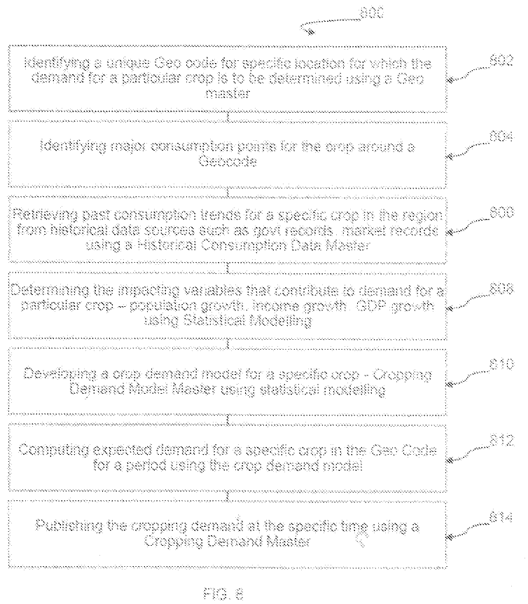

FIG. 8 is a flow chart representing an example of a program 800 that can be executed for crop demand for a specific geo code model, according to an embodiment of the present invention. In an embodiment, an analytics core engine module 208 includes a demand determination module 338. The demand determination module 338 generates forecasts for perishables based on the historical market data and other independent parameters viz. inflation, population growth, income growth etc. by executing at step 802, identifying a unique Geo code for specific location for which the demand for a crop is to be determined using a Geo master and at step 804, identifying major consumption points for the crop around a Geocode.

Further, at step 806, retrieving past consumption trends for a specific crop in the region from historical data sources such as govt records, market records using a Historical Consumption Data Master and at step 808, determining the impacting variables that contribute to demand for a crop such as population growth, income growth, Gross Domestic Product (GDP) growth using statistical modelling. The program further executes at step 810, developing a crop demand model for a specific crop using a Cropping Demand Model Master using statistical modelling and at step 812, computing expected demand for a specific crop in the Geo Code for a period using the crop demand model to further publish the cropping demand at the specific time using a Cropping Demand Master at step 814.

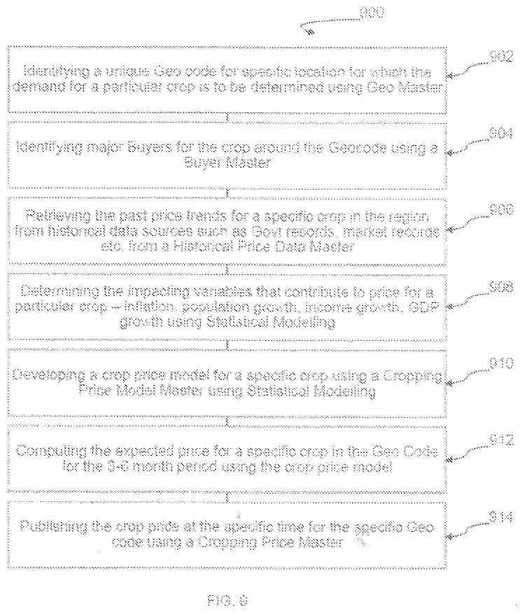

FIG. 9 is a flow chart representing an example of a program 900 that can be executed for target market price for a specific crop model, according to an embodiment of the present invention. In an embodiment, an analytics core engine module 208 includes a target market price determination module 340. The target market price determination module 340 provides a forecasted or anticipated market price of post-harvest crops based on historical trends, seasonal data as well as the supply demand situation expected based on the statistical and predictive modelling.

The module executes at step 902, by identifying a unique Geo code for specific location for which the demand for a crop is to be determined using a Geo Master and at step 904, identifying major Buyers for the crop around the Geocode using a Buyer Master. Further, at step 906, retrieving the past price trends for a specific crop in the region from historical data sources such as Govt. records, market records etc. from a Historical Price Data Master, at step 908, determining the impacting variables that contribute to price for a crop, such as inflation, population growth, income growth, GDP growth using statistical modelling. Further at step 910, developing a crop price model for a specific crop using a Cropping Price Model Master using statistical modelling and at step 912, computing the expected price for a specific crop in the Geo Code for the 3-6 months period using the crop price model. The crop prices are published at the specific time for the specific Geo code using a Cropping Price Master at step 914. This information would enable decision making by the farmers to decide how much to grow a specific crop as to maximize the opportunity for their farm holding.

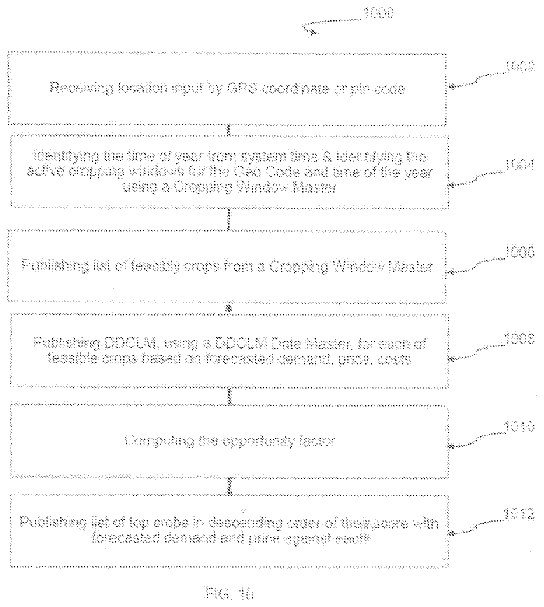

FIG. 10 is a flow chart representing an example of a program 1000 that can be executed for crop opportunity sizing and prioritization model, according to an embodiment of the present invention. In an embodiment, an analytics core engine module 208 includes a crop opportunity sizing & prioritizing module 342. The crop opportunity sizing & prioritizing module 342 identifies the best performance crops based on complex algorithms that factor in location information, time of the year, historical patterns of demand, pricing, consumption, cultivation, and forecasted weather, and demand. The crop opportunity sizing & prioritizing module 342 is a dynamic engine that updates the recommendations based on changing dynamics including the expected cultivation of the same crop in the same catchment region. The module provides a prioritized list of 3 crops that have the maximum potential for profitability for the farmers for a region/location. This listing of the top 3 crops is dynamic and changes based on the dynamic inputs like weather, season progress, growth patterns of other farmers based on direct data and or satellite imagery. So, at the start of a cropping window, the top 3 crops could be different and as the cropping window moves forward, based on the analytics of the surround aspects, the module either changes the priority levels of the 3 crops or changes the opportunity size so that farmers can take the decision which assures them the best profitability.

The program is executed at step 1002 by receiving location input by GPS coordinate or pin code and at step 1004, identifying the time of year from system time & Identifying the active cropping windows for the Geo Code and time of the year using a Cropping Window Master. Further, at step 1006, publishing list of feasibly crops from a using a Cropping Window Master and at step 1008, publishing DDCLM, using a DDCLM Data Master, for each of feasible crops based on forecasted demand, price, costs. Based on DDCLM, identify top 3 crops with highest forecasted demand, assign Demand Ranking Score (DRS) of 3, 2, 1 with 3 for highest demand. Based on DDCLM, identify top 3 crops with highest forecasted Price, assign Price Ranking Score (PRS) of 3, 2, 1 with 3 for highest price. Based on DDCLM, identify top 3 crops with lowest Input Costs, assign Input Cost Ranking Score (ICRS) of 3, 2, 1 with 3 for lowest cost. Further, compute the Opportunity Factor (OF) at step 1010 by multiplying DRS*PRS*ICRS score and list the three crops in descending order of the Opportunity Factor (OF) to publish list of the 3 crops in descending order of their score with forecasted Demand and Price against each at step 1012. This module also calculates the recommended farm land that needs to be committed to the crop selected to maximize the opportunity. This is calculated based on the expected yield that is based on the expected weather, soil type and probability of adverse impact of pests etc.

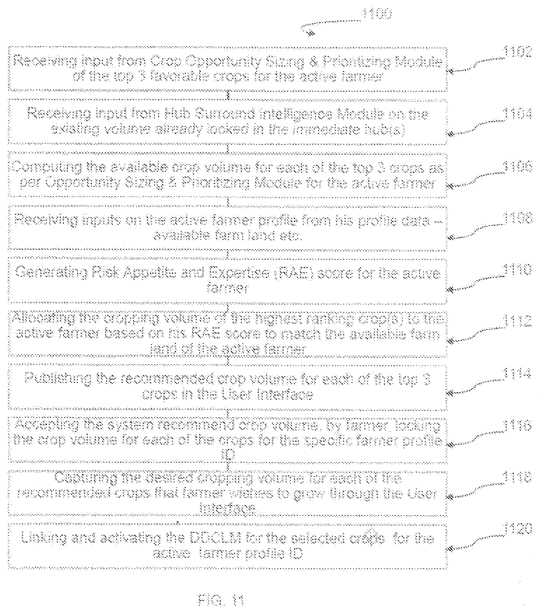

FIG. 11 is a flow chart representing an example of a program 1100 that can be executed for cropping area recommendation for a specific farmer model, according to an embodiment of the invention; In an embodiment, an analytics core engine module 208 includes a cropping area recommendation module 344. The cropping area recommendation module 344 generates target cropping area volume that is optimal for farmers maximizing their profitability. The module matches the allocation of the crops with the highest profitability potential with a Risk Appetite and Expertise (RAE) score of each of the farmers which is determined for each farmer based on his profile data captured as well as his historic feedback and performance score.

The cropping area recommendation module 344 first calculates the available volume for each of the top 3 crops available based on multiple validations as executed by a Hub Surround Intelligence Module I.e. Self-declared production volume provided directly by participating farmer(s), Satellite imagery/drone base imagery etc. The calculations happen by executing at step 1102, receiving input from a Crop Opportunity Sizing & Prioritizing Module 342 of the top 3 favorable crops for an active farmer and at step 1104, receiving input from an Hub Surround Intelligence Module 330 on the existing volume already locked in the immediate hub(s). Further, at step 1106, computing the available crop volume for each of the top 3 crops as per the Crop Opportunity Sizing & Prioritizing Module 342 for the active farmer and at step 1108, receiving inputs on the active farmer profile from his profile data such as available farm land etc. A Risk Appetite and Expertise (RAE) score for the active farmer is generated at step 1110 and thus allocating the cropping volume of the highest-ranking crop(s) to the active farmer based on his RAE score to match the available farm land of the active farmer at step 1112. It further publishes, at step 1114, a recommended crop volume for each of the top 3 crops in a User Interface 102 and at step 1116, accepting the system recommend crop volume, by farmer, locking the crop volume for each of the crops for a specific farmer profile ID. Further at step 1118, capturing a desired cropping volume for each of the recommended crops that farmer wishes to grow through the User Interface 102 and linking and activating the DDCLM for the selected crops for the active farmer profile ID at step 1120.

Based on these data inputs the system algorithms allocate the quantity to all new farmers such that the collective profitability of the all the associated farmers is maximized matching it with the RAE score of the specific farmer. Simplistically, if the total demand for a crop is 100 units and already 80 units have been confirmed to be planned by a farmer or set of farmers, the new farmer interested in cropping that same crop would be advised 20 units as the maximum that he should target to grow.

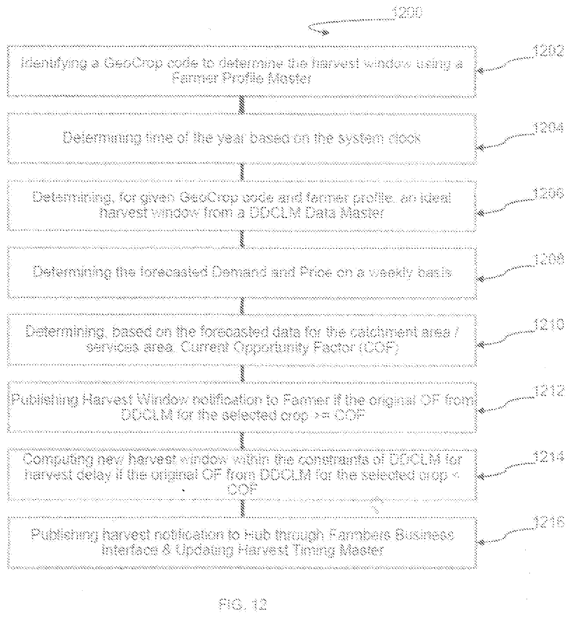

FIG. 12 is a flow chart representing an example of a program 1200 that can be executed for harvest timing & sizing model, according to an embodiment of the present invention. In an embodiment, an analytics core engine module 208 includes a harvest timing & sizing module 346. The harvest timing & sizing module 346 provides accurate harvest timing intelligence. The module uses complex algorithms to identify and prioritize the harvest activities so as the harvest is aligned with the market demand. At step 1202, identifying a GeoCrop code to determine the harvest window using the Farmer Profile Master and at step 1204, determining time of the year based on the system clock to further determine at step 1206, for given GeoCrop code and farmer profile, an ideal harvest window from a DDCLM Data Master.

Further, at step 1208, determining a forecasted Demand and Price on a weekly basis to determine a Current Opportunity Factor (COF) based on the forecasted data for the catchment area/services area at step 1210. Further, at step 1212, publishing a Harvest Window notification to the farmer if the original OF from DDCLM for the selected crop>=COF and at step 1214, computing new harvest window within the constraints of DDCLM for harvest delay if the original OF from DDCLM for the selected crop<COF and thus publish harvest notification to Hub through a business interface 202 & updating a Harvest Timing Master. The algorithms in this module utilizes recent consumption patterns, market prices, upcoming demand, demand changes because of festivals social events that may result in either a drop or spike in the potential demand, potential impact of severe weather to generate guidance and recommendation for the farmers to help them maximize their profits.

In an embodiment of the present invention, process steps are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer-executable instructions. These computer-executable instructions may be loaded onto a general-purpose computer, a special purpose computer, or other programmable computing device or data processing apparatus to produce a machine, such that the computer-executable instructions which execute on the computer or the other programmable computing device or data processing apparatus create a means for implementing the functions specified in the flowchart block or blocks.

These computer-executable instructions may also be stored in a computer-readable memory that can direct a computer or other programmable computing device or data processing apparatus to function in a manner, such that the instructions stored in the computer-readable memory produce an article of manufacture including computer-readable computer-executable instructions for implementing the function specified in the flowchart block or blocks. The computer program instructions may also be loaded onto a computer or other programmable computing device or data processing apparatus to cause a series of operational steps to be performed on the computer or the other programmable computing device or apparatus to produce a computer-implemented process such that the computer-executable instructions that execute on the computer or the other computing device or programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block (e.g., unit, interface, processor, or the like) of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The embodiments in the specification are described in a progressive manner and focus of description in each embodiment is the difference from other embodiments. For same or similar parts of each embodiment, reference may be made to each other. Because the method disclosed in the embodiment is corresponding to the apparatus disclosed in the embodiment, the description of the method is simple. For related parts, reference may be made to the description of the apparatus.

It will be appreciated by those skilled in the art that the foregoing description was in respect of preferred embodiments and that various alterations and modifications are possible within the broad scope of the appended claims without departing from the spirit of the invention with the necessary modifications.

Based on the description of disclosed embodiments, persons skilled in the art can implement or apply the present disclosure. Various modifications of the embodiments are apparent to persons skilled in the art, and general principles defined in the specification can be implemented in other embodiments without departing from the spirit or scope of the present disclosure. Therefore, the present disclosure is not limited to the embodiments in the specification but intends to cover the most extensive scope consistent with the principle and the novel features disclosed in the specification.

What is claimed is:

1. A system for crop lifecycle modeling, comprising:
a computer processor; and
at least one computer-readable storage medium operably coupled to the computer processor and having program instructions stored therein, the computer processor being operable to execute the program instructions to generate a profile of a crop using a plurality of data processing modules including,
a data acquisition module (106) configured to receive, periodical input data from at least one source, wherein the data is related to at least one of factors contributing to production of the crop;
a data storage module (108) adapted to process and store the received input data;
an analytics core module (208) configured to generate an output data using the input data from the data storage module (108) for processing and computing the input data to create a predictive crop lifecycle model, wherein the analytics core module (208) is adapted to work with a crop lifecycle rules engine (332) and provide input to improve and enhance the rules engine (332);
an interface module (102) configured to process and transfer the output data, instructions and conduct transaction between multiple users of the data processing modules;
a report module configured to generate an action report from the interface module based on the data of the analytics core module.

2. The system according to claim 1, wherein the factors contributing to production of the crop includes at least one of geography, demographics, soil condition, market condition, weather, and government policy.

3. The system according to claim 1, wherein the analytics core module (208), for creating a predictive model, further comprises:
a provisioning & rendering module (328), a dynamic digital crop lifecycle modeling module (334), a cropping window detection module (336), a demand determination module (338), a target market price determination module (340), a crop opportunity sizing & prioritizing module (342), a cropping area recommendation module (344), a harvest timing & sizing module (346), and a hub surround intelligence module (330), wherein the modules generates instructions for at least one of maximizing yield, determining demand, calculating target price, identifying right crop opportunity.

4. The system according to claim 1, wherein the analytics core module (208) provides the inputs to improve and enhance instructions underlying in the data processing, computing, and instructions generating modules.

5. The system according to claim 1, further comprising an interface layer of the interface module (102) configured to work with an acquisition interface layer of an acquisition module.

6. The system according to claim 1, wherein the data received is generated in real time or dynamically.

7. The system according to claim 1, further comprising a localization engine (204) to convert the output data of the analytics core module (208) into a set of instructions.

8. The system according to claim 1, wherein the data processing and computing modules of the analytics core module (208), utilizes multi correlation instructions and analytics, and generates a set of instructions to optimize crop production.

9. A method for crop lifecycle modeling, comprising:
receiving periodical input data from at least one source, wherein the data is related to at least one of factors contributing to production of the crop; storing the received input data;
computing an output data using the input data for creating a predictive crop lifecycle model using a crop lifecycle rules engine and provide input to improve and enhance the rules engine;
transferring the output data, instructions and conducting transaction between multiple users;
generating periodical reports to users based on the predictive crop lifecycle model.

10. The method according to claim 9, wherein the factors contributing to production of the crop includes at least one of geography, demographics, soil condition, market condition, weather, and government policy.

11. The method according to claim 9, wherein computing the input data for creating a predictive crop lifecycle model further comprises: providing a unique framework for developing a structured database of a digital model; generating a dynamic digital crop lifecycle model; determining a cropping window model; determining a demand volume; determining a target market price; identifying crop opportunity size; recommending a cropping area; recommending a harvest time; validating the predictive crop lifecycle model using a hub surround data.

12. The method according to claim 9, further comprising converting the output data into a set of instructions to optimize crop production.

13. A method implemented by a computer for crop lifecycle modelling, comprising:
receiving dynamic input data wherein the input data is related to at least one of factors contributing to production of the crop;
generating contextual instructions and a predictive crop lifecycle model by computing the dynamic input data using rules from a rules engine for users;
improving and enhancing the rules engine using the generated contextual instructions.

14. The method according to claim 1 further comprising processing, by a computer, and storing the received input data.

15. The method according to claim 13, wherein generating contextual instructions further comprises: transferring an output data, instructions and conducting transaction between multiple users.

16. The method according to claim 13, further comprising providing periodical reports to users based on the predictive crop lifecycle model.

17. The method according to claim 13, wherein the factors contributing to production of the crop includes at least one of geography, demographics, soil condition, market condition, weather, and government policy.

18. The method according to claim 13, wherein computing the input data for creating a predictive crop lifecycle model further comprises: providing a unique framework for developing a structured database of a digital model; generating a dynamic digital crop lifecycle model; determining a cropping window model; determining a demand volume; determining a target market price; identifying crop opportunity size; recommending a cropping area;
recommending a harvest time; validating the predictive crop lifecycle model using a hub surround data.

19-20. (canceled)
